(19) United States
(12) Patent Application Publication
(10) Pub. No.: US 2006/0119277 A1
(43) Pub. Date: Jun. 8, 2006

(54) Heater drive circuit

(75) Inventors: Takeshi Ito, Kanagawa (JP); Keiichi Enomoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: JIDOSHA DENKI KOGYO CO., LTD., Yokohama-shi (JP)

(21) Appl. No.: 11/260,234

(22) Filed: Oct. 28, 2005

(30) Foreign Application Priority Data
Oct. 29, 2004 (JP) P.2004-316095

(51) Int. Cl. H05B 39/04; H05B 41/36

(52) U.S. Cl. 315/106

(57) ABSTRACT

Provided is a heater drive circuit that applies a voltage to a heater resistor in detecting a temperature variation in accordance with the concentration of a predetermined element contained in a liquid, the heater drive circuit including: a booster circuit for boosting a predetermined reference power source voltage to generate a boosted power source voltage; a voltage control circuit including an operational amplifier driven by a boosted power source voltage from the booster circuit; and an emitter follower output circuit having its base terminal connected to an output voltage from the heater resistor, its collector terminal connected to the predetermined reference power source, and its emitter terminal connected to the heater resistor.

This application claims priority based on Japanese Patent application no. 2004-316095, filed Oct. 29, 2004, the contents of which is incorporated herein by reference in its entirety. This priority claim is being made concurrently with the filing of the application.

### BACKGROUND OF THE INVENTION

The present invention relates to a heater drive circuit mounted on a vehicle or the like, the circuit driven to detect the thermal resistance of a liquid in a bridge circuit when determining whether urea water for a urea SCR (Selective Catalyst Removing method) catalyst decomposing NOx into water and hydrogen has an appropriate urea concentration.

In the related art, for example, a urea concentration sensor for an exhaust gas purification system for a diesel is known that amplifies a faint signal of 0.1 mV or below and performs A/D conversion of the resulting signal using a microcomputer to detect urea water having an appropriate concentration. A technology used in such a urea concentration sensor is a high-voltage power source circuit described in Patent Reference 1 that supplies voltage to a heater resistor.

Patent Reference 1: JP-A-07-107737

A heater drive circuit or operating the urea concentration sensor is mounted on a diesel engine vehicle. Thus, a power source of a 24V system must be provided to feed a power source voltage to the sensor circuit and apply a predetermined voltage from a low-voltage output circuit to a heater resistor.

Use of a high voltage from a power source of a 24V system requires serge protection and loss reduction in the heater drive circuit. This results in a larger circuit scale.

In the related art, as shown in FIG. 5, it is necessary to convert a high voltage to a reference voltage of 5V by using a switching regulator 101 as a power source circuit and supply the voltage of 5V to a CPU 102 as well as convert it to 3.45V and supply the voltage of 3.45V to a heater resistor. The problem with this approach is that only a low voltage of 3.3V is supplied to the heater resistor because of a voltage drop of 0.5V caused by an operational amplifier 103 in a voltage control circuit and a voltage drop of 1.2V caused by a transistor 104 in an output circuit. That is, the total voltage drop includes a voltage drop caused by the power source of the operational amplifier 103 minus maximum saturation voltage and a voltage drop caused by Vbe of the transistor 104.

### SUMMARY OF THE INVENTION

The invention is proposed in view of the aforementioned circumstances. An object of the invention is to provide a heater drive circuit capable of supplying a proper voltage to a heater resistor even in the presence of a voltage drop of a circuit element up to the heater resistor.

In order to solve the problems, according to a first aspect of the invention, there is provided with a heater drive circuit that applies a voltage to a heater resistor in detecting a temperature variation in accordance with the concentration of a predetermined element contained in a liquid, the heater drive circuit including: a booster circuit for boosting a predetermined reference power source voltage to generate a boosted power source voltage; a voltage control circuit including an operational amplifier which is driven by a boosted power source voltage from the booster circuit and compares the output voltage with the predetermined reference power source voltage to control the voltage to the heater resistor; and a switching element connected to the voltage control circuit, the heater resistor and the predetermined reference power source.

According to a second aspect of the invention, there is provided with the heater drive circuit according to the first aspect, wherein the switching element is an emitter follower output circuit having a base terminal connected to an output voltage from the voltage control circuit, a collector terminal connected to the predetermined reference power source, and an emitter terminal connected to the heater resistor.

According to a third aspect of the invention, there is provided with the heater drive circuit according to the first aspect, wherein the switching element is an FET having a gate terminal connected to an output voltage from the voltage control circuit, a drain terminal connected to the predetermined reference power source, and a source terminal connected to the heater resistor.

According to the heater drive circuit of the invention, it is possible to generate a boosted power source voltage in a booster circuit while considering a voltage drop in a voltage control circuit or an output circuit even in case such a control circuit or output circuit is provided, thereby stably supplying a predetermined voltage appropriate for a heater resistor.

### BRIEF DESCRIPTION OF THE DRAWINGS

FIG. 1 is a block diagram showing an overall configuration of a urea water detection system to which the invention is applied;

FIG. 2 is a block diagram showing a urea water detection system including a heater drive circuit to which the invention is applied;

FIG. 3 is a circuit diagram of a booster circuit, a voltage control circuit and an output circuit in the heater drive circuit to which the invention is applied;

FIG. 4 shows the relationship between a heater output and a temperature variation detected by a temperature sensor;

FIG. 5 is a block diagram showing the configuration of a related art heater drive circuit; and

FIG. 6 is a circuit diagram of a booster circuit, a voltage control circuit and an output circuit in the heater drive circuit to which the invention is applied.

### DETAILED DESCRIPTION OF THE PREFERRED EMBODIMENTS

Embodiments of the invention will be described referring to drawings.

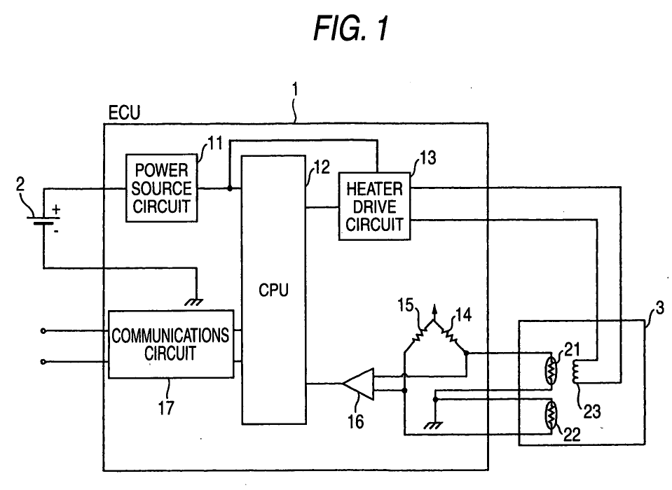

The invention is applied to a heater drive circuit 13 for example in a urea water detection system configured as shown in FIG. 1. The urea water detection system mounted for example on a vehicle traveling by way of a diesel engine detects the urea concentration of urea water for a urea SCR catalyst and supplies the detected concentration value to an exhaust gas purification system (not shown).

[Configuration of Heater Drive Circuit]

A urea water detection system including a heater drive circuit mainly comprises, as shown in FIG. 1, an ECU 1, an ignition power source 2 activated with an ignition switch of a vehicle and a detection circuit 3 both of which are connected to the ECU 1. When the ignition switch (IGN) (not shown) of the system is turned on, an ignition voltage is supplied to the ECU 1 from the ignition power source 2 as a power source of a 24V system.

The ignition voltage is a voltage from a power source of a 24V system, for example. The ignition voltage is first supplied to a power source circuit 11 in the ECU 1, converted to an operating voltage for a CPU 12, and supplied to a heater drive circuit 13 from the CPU 12. The heater drive circuit 13 converts the voltage supplied by the CPU 12 to a predetermined operating voltage for a detection circuit 3 in accordance with the control by the CPU 12.

This causes the detection circuit 3 to amplify, on the operational amplifier 16 in the ECU 1, the detected output varying depending on the presence/absence of urea-containing water and presence of a urea concentration appropriate for the urea-containing water, and supplies the resulting output value to the CPU 12. The CPU 12 performs arithmetic operation to convert the output value from the operational amplifier 16 to the urea concentration of the urea-containing water and supplies the urea concentration value to an exhaust gas purification system (not shown) via a communications circuit 17.

A sensor circuit whose output depends on the urea concentration of urea water includes a bridge circuit including a resistor 14, a temperature sensor 21, a resistor 15, and a temperature sensor 22 as a resistor, all of these components bridge-connected. The bridge circuit has one end connected to a reference voltage IC and the other end connected to a GND terminal. The resistors 14, 15 are for example carbon resistors. The temperature sensors 2l, 22 are for example platinum resistors. A resistance value of a platinum resistor has a large variation in temperature of approximately 3600 ppm/° C. The resistors 14, 15 are arranged in the air while the temperature sensors 21, 22 are arranged in urea water.

One resistor among the resistor 14, temperature sensor 21, resistor 14 and temperature sensor 22, for example the temperature sensor 21 is integrated with a heater resistor 23. The heater resistor 23 is heated and the heat of the same is transmitted. The heater resistor 23 is heated for a predetermined duration by predetermined interval, which causes the resistance value of the temperature sensor 21 to vary periodically. The temperature sensors 21, 22 are arranged in the urea water filled in a urea water tank. The higher the urea concentration of the urea water is, the less the dissipation of heat transmitted to the temperature sensor becomes, thus the more slowly the resistance value of the temperature sensor is restored. The lower the urea concentration of the urea water is, the faster the heat at the temperature sensor is dissipated. The ratio of variations at a junction point of the resistor 12 and the temperature sensor 21 in the bridge circuit is proportional to the urea concentration.

In the sensor circuit, with an operating voltage applied by a reference voltage IC, the heat from the heater resistor 23 integrated with the temperature sensor 21 increases the resistance value of the temperature sensor 21. The heat from the temperature sensor 21 is dissipated into the urea water to decrease the resistance value. The voltage value divided by the resistor 14 and the temperature sensor 21 and the voltage value divided by the resistor 15 and the temperature sensor 22 are supplied to an operational amplifier 16. The operational amplifier 16 calculates the difference between the voltage value divided by the resistor 14 and the temperature sensor 21 and the voltage value divided by the resistor 15 and the temperature sensor 22 and amplifies the obtained differential voltage and transmits the corresponding output signal to the CPU 12.

The degree of dissipation of urea-containing water is detected in accordance with the urea concentration by the temperature sensor 21, and the detection output depending on the presence/absence of urea-containing water and presence of a urea concentration appropriate for the urea-containing water is supplied to the CPU 12.

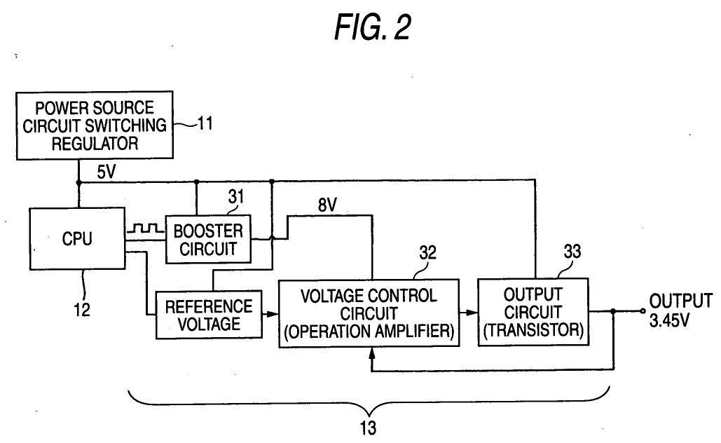

As shown in FIG. 2, a voltage of 5V generated by the power source circuit 11 is supplied to a booster circuit 31 of the heater drive circuit 13 and supplied as a reference voltage to a voltage control circuit 32 and an output circuit 33 connected to the heater resistor 23.

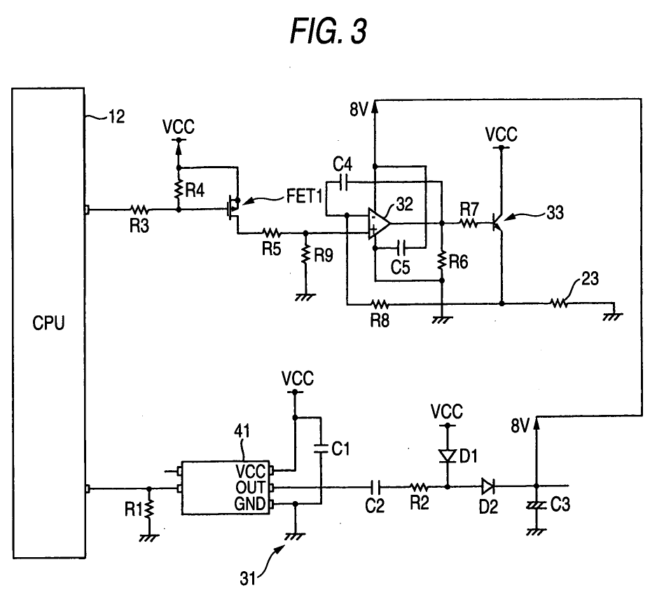

As shown in FIG. 3, the booster circuit 31 comprises an inverter circuit 41 connected thereto via the CPU 12 and a resistor R1 (10 kΩ). The inverter circuit 41 comprises a terminal for inputting a pulse signal from the CPU 12, a terminal for supplying a 5V reference voltage VCC from the power source circuit 11, a terminal connected to a GND, and a terminal for outputting a boosted voltage. The inverter circuit 41 outputs a reference voltage of 5V as an 8V power source voltage to a voltage control circuit 32 generated from the pulse signal input from the CPU 12. The inverter circuit 41 is provided with a capacitor C1 (0.1 μF) between the terminal connected to the reference voltage and the GND.

The output pulse signal from the inverter circuit 41 is transmitted by a circuit including a capacitor 2 (1 μF), a resistor R2, diodes D1, D2 and a capacitor C3, and supplied as a boosted voltage of 8V to the voltage control circuit 32.

The output circuit 33 is an emitter follower circuit that has a collector terminal of transistor connected to a reference power source of 5V, a base terminal connected to the voltage control circuit 32, and an emitter terminal connected to the heater resistor 23.

As shown in FIG. 3, the voltage control circuit 32 comprises an FET 1 whose gate terminal receives a pulse signal via a resistor R3 (10 kΩ) and a resistor R4 (47 kΩ), the voltage control circuit 32 as an operational amplifier, and the output circuit 33 as a transistor. The voltage control circuit 32 compares the reference voltage of 5V with the output voltage of the output circuit 33 to control the output voltage to the output circuit 33. The voltage control circuit 32 has an output terminal connected to a transistor base terminal as an output circuit 33 via a resistor R7 (100Ω). The voltage control circuit 32 is connected to a drive voltage of 8V as a drive power source voltage and a reference voltage of 5V via a capacitor C5 (0.1 μF). Further, the voltage control circuit 32 has a negative terminal grounded via a resistor R6 (10 kΩ) and a capacitor C4 (100 pF) and a positive terminal connected to the drain terminal of the FET 1.

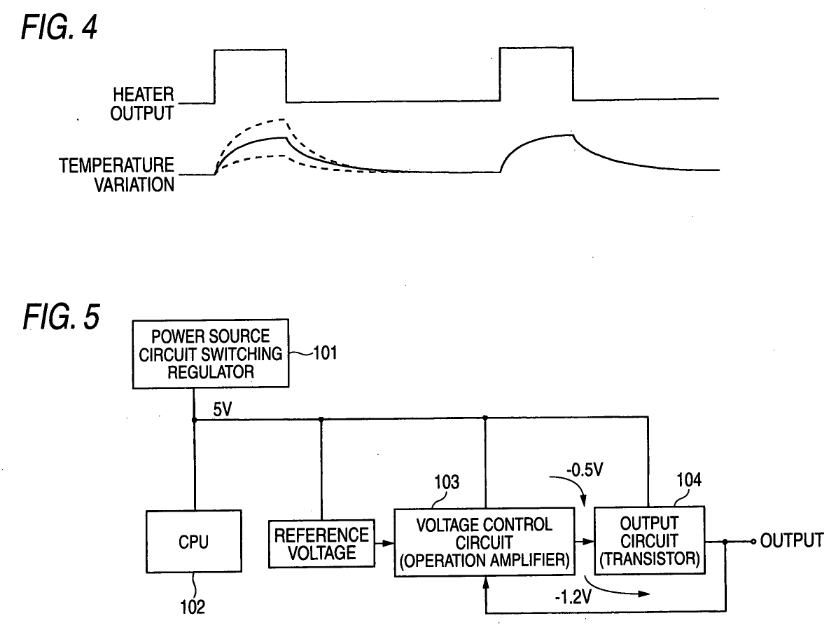

In case a voltage is supplied to the heater 23 by the heater drive circuit 13, for example, a voltage of 3.45V is applied to the heater resistor 23 by the heater drive circuit 13 for a predetermined duration by predetermined interval, as shown in FIG. 4. The CPU 12 outputs a pulse signal to the booster circuit 31 to convert the reference voltage of 5V to an 8V power source voltage and supplies the 8V voltage to the voltage control circuit 32. At the same time, the CPU 12 outputs a pulse signal to the FET 1 to generate a voltage of 3.45V dropped by the voltage control circuit 32 and the output circuit 33.

This causes the temperature of the urea-containing water to vary. As shown in the dotted lines in FIG. 4, a temperature variation is detected by the temperature sensors 21, 22 based on the high/low urea concentration. The temperature variation value is converted to a urea concentration by the CPU 12.

The heater drive circuit thus configured converts the reference voltage of 5V to a higher 8V voltage on the booster circuit 31 and connect the 8V voltage to the voltage control circuit 32. The voltage control circuit 32 is capable of supplying a voltage higher than the reference voltage of 5V to the heater resistor 23 via the output circuit 33. Thus, according to the heater drive circuit 13, it is possible to reliably supply a predetermined voltage of 3.45V to the heater resistor 23 by using the 8V voltage of the booster circuit 31, even in the presence of a voltage drop caused by the voltage control circuit 32 and a voltage drop caused by the output circuit 33.

The heater drive circuit 13 uses the reference voltage of 5V converted by the power source circuit 11 as a circuit voltage for the booster circuit 31. This eliminates the need for losses caused by surge protection and voltage drop.

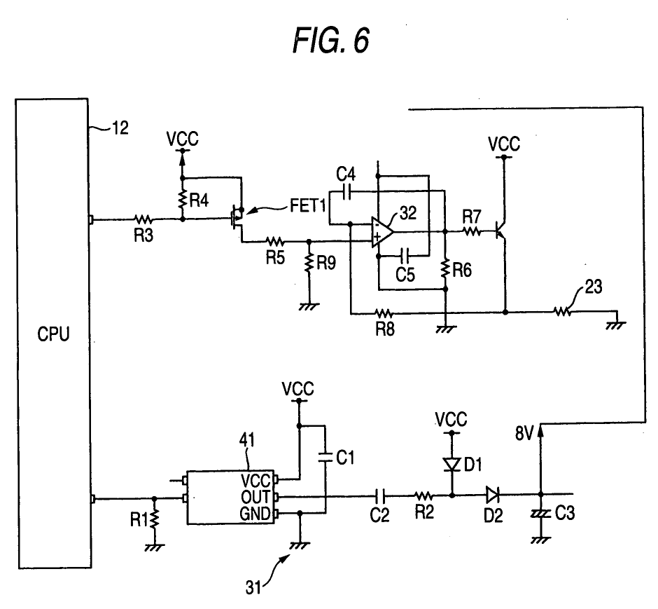

Further, in FIG. 6, the transistor as shown in FIG. 3 is replace with an FET (Field Effect Transistor).

The foregoing embodiment is an example of the invention. The invention is not limited to the above embodiment but various changes may be made to the invention depending on the design or the like within the technical philosophy of the invention.

What is claimed is:

1. A heater drive circuit that applies a voltage to a heater resistor in detecting a temperature variation in accordance with the concentration of a predetermined element contained in a liquid, the heater drive circuit comprising:
a booster circuit for boosting a predetermined reference power source voltage to generate a boosted power source voltage;
a voltage control circuit including an operational amplifier which is driven by a boosted power source voltage from the booster circuit and compares the output voltage with the predetermined reference power source voltage to control the voltage to the heater resistor; and
a switching element connected to the voltage control circuit, the heater resistor and the predetermined reference power source.

2. The heater drive circuit according to the claim 1, wherein
the switching element is an emitter follower output circuit having a base terminal connected to an output voltage from the voltage control circuit, a collector terminal connected to the predetermined reference power source, and an emitter terminal connected to the heater resistor.

3. The heater drive circuit according to the claim 1, wherein
the switching element is an FET having a gate terminal connected to an output voltage from the voltage control circuit, a drain terminal connected to the predetermined reference power source, and a source terminal connected to the heater resistor.
